(19) United States
(12) Patent Application Publication
(10) Pub. No.: US 2024/0399572 A1
(43) Pub. Date: Dec. 5, 2024

(54) UNSUPERVISED COMPOSABLE SKILLS DISCOVERY THROUGH AUTOMATIC TASK GENERATION FOR ROBOTIC MANIPULATION

(71) Applicants: NAVER CORPORATION, Gyeonggi-do (KR); NAVER LABS CORPORATION, Gyeonggi-do (KR)

(72) Inventors: Paul JANSONNIE, Darmstadt (DE); Bingbing WU, Villard-Bonnot (FR); Julien PEREZ, Grenoble (FR)

(73) Assignees: NAVER CORPORATION, Gyeonggi-do (KR); NAVER LABS CORPORATION, Gyeonggi-do (KR)

(21) Appl. No.: 18/205,726

(22) Filed: Jun. 5, 2023

(51) Int. Cl. B25J 9/16

(52) U.S. Cl. CPC B25J 9/1661; B25J 9/163; B25J 9/1653; B25J 9/1664; B25J 9/1697

(57) ABSTRACT

A training system for a robot includes: a task solver module including primitive modules and a policy and configured to determine how to actuate the robot to solve input tasks; and a training module configured to: pre-train ones of the primitive modules for different actions, respectively, of the robot and the policy of the task solver module using asymmetric self play and a set of training tasks; and after the pre-training, train the task solver module using others of the primitive modules and tasks that are not included in the set of training tasks.

### FIELD

The present disclosure relates to robot systems and methods and more particularly to systems and methods for automatically generating robotic manipulation tasks that the robot was not previously trained to perform.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are one type of robot and are an example of an autonomous system that is mobile and may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants/humans from a pickup to a destination. Another example of a navigating robot is a robot used to perform one or more functions inside a residential space (e.g., a home).

Other types of robots are also available, such as residential robots configured to perform various domestic tasks, such as putting liquid in a cup, filling a coffee machine, etc.

### SUMMARY

In a feature, a training system for a robot includes: a task solver module including primitive modules and a policy and configured to determine how to actuate the robot to solve input tasks; and a training module configured to: pre-train ones of the primitive modules for different actions, respectively, of the robot and the policy of the task solver module using asymmetric self play and a set of training tasks; and after the pre-training, train the task solver module using others of the primitive modules and tasks that are not included in the set of training tasks.

In further features, the policy of the task solver module is a multiplicative compositional policy (MCP).

In further features, the primitive modules are associated with distributions over actions, respectively, where the policy of the task solver module is a multiplicative composition of the distributions, and where the multiplicative composition of the distributions defines a repertoire of composable skills for the robot.

In further features, the asymmetric self play the training module includes presenting the task solver module with tasks of increasing difficulty over time.

In further features, the task solver module includes a gating function that includes weights to apply to outputs of the primitive modules, respectively.

In further features, the training module is configured to train the weights.

In further features, each of the primitive modules is modeled by a Gaussian distribution.

In further features, the policy is configured to maximize an expected discounted sum over a horizon.

In further features, each of the primitive modules includes an embedding module configured to generate an embedding based on at least one measurement from at least one sensor of the robot, and the robot includes a control module configured to actuate one or more actuators of the robot based on the embedding.

In further features, the embedding module includes at least one fully connected layer.

In further features, each of the primitive modules includes an embedding module configured to generate an embedding based on at an image captured using a camera of the robot, and the robot includes a control module configured to actuate one or more actuators of the robot based on the embedding.

In further features, the embedding module includes at least one fully connected layer.

In further features, each of the primitive modules includes an embedding module configured to generate an embedding based on a position and a pose of an object to be manipulated by the robot, and the robot includes a control module configured to actuate one or more actuators of the robot based on the embedding.

In further features, the embedding module includes at least one fully connected layer.

In further features, each of the primitive modules includes an embedding module configured to generate an embedding based on a target position and a target pose of an object to be manipulated by the robot, and the robot includes a control module configured to actuate one or more actuators of the robot based on the embedding.

In further features, the embedding module includes at least one fully connected layer.

In further features, each of the primitive modules includes: a first embedding module configured to generate a first embedding based on at least one of (a) at least one measurement from at least one sensor of the robot and (b) an image captured using a camera of the robot; and a second embedding based on at least one of (a) a position and a pose of an object to be manipulated by the robot and (b) a target position and a target pose of the object to be manipulated by the robot, where the robot includes a control module configured to actuate one or more actuators of the robot based on the first embedding and the second embedding.

In further features, each of the primitive modules further includes a concatenation module configured to generate a third embedding by concatenating the first and second embeddings, where the control module is configured to actuate the one or more actuators of the robot based on the third embedding.

In further features, each of the primitive modules includes an embedding module configured to generate an embedding based on time steps since a beginning of an episode of the training, and the robot includes a control module configured to actuate one or more actuators of the robot based on the embedding.

In a feature, a training method for a robot includes: pre-training ones of primitive modules for different actions, respectively, of the robot and a policy of a task solver module using asymmetric self play and a set of training tasks, the task solver module including the primitive modules and the policy and configured to determine how to actuate the robot to solve input tasks; and after the pre-training, training the task solver module using others of the primitive modules and tasks that are not included in the set of training tasks.

In a feature, a training system for a robot includes: a first means including primitive modules and a policy and for determining how to actuate the robot to solve input tasks; and a second means for: pre-training ones of the primitive modules for different actions, respectively, of the robot and the policy using asymmetric self play and a set of training tasks; and after the pre-training, training the first means using others of the primitive modules and tasks that are not included in the set of training tasks.

In a feature, a robot includes: a task solver module including primitive modules and a policy and configured to determine how to actuate the robot to solve an input task, each of the primitive modules including an embedding module configured to generate an embedding based on at least one measurement from at least one sensor of the robot; and a control module configured to actuate one or more actuators of the robot based on the embedding, where the policy encodes a repertoire of composable skills for performing the input task.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 and 2 are functional block diagrams of example robots;

FIG. 3 includes a functional block diagram of an example training system;

FIG. 4 includes a functional block diagram including an example implementation of a task solver module;

FIGS. 5 and 6 include functional block diagrams of an example implementation of the primitives (modules); and

FIG. 7 includes a flowchart depicting an example training and deployment method.

In the drawings, reference numbers may be reused to identify similar and/or identical elements.

### DETAILED DESCRIPTION

A robot may include a camera. Images/video from the camera and measurements from other sensors of the robot can be used to control actuation of the robot, such as propulsion, actuation of one or more arms, and/or actuation of a gripper. Video from the camera can also be used to recognize the performance of various types of actions performed in the video, such as actions performed by animals (e.g., humans).

Skill discovery can be used by a robot to learn complex and diverse behaviors/skills that could be reused for numerous tasks, such as in locomotion and navigation. New skill discovery, however, may be difficult in robotic manipulation scenarios, such skills for interactions with objects, such as moving objects, etc.

The present application involves reusable and composable skill learning systems and methods based on an automatic task generation processes and a structural definition of behavior composition. By training a Multiplicative Compositional Policy (MCP) to solve a curriculum of automatically generated distribution of diverse and complex tasks, a robot control module may learn robust and composable set of skills that can be reused to solve unseen downstream tasks with minimal additional training.

Robotic manipulation is a challenging problem for reinforcement learning (RL), and more particularly for Goal-Conditioned RL (GCRL). Manipulation tasks may involve sparse rewards which may increase a complexity of learning a successful policy that serves as a task solver/generator module. One example is the task of block stacking involving an robot grasping a block and stacking that block on top of another block. Learning block stacking may involve a hand designed curriculum, reward shaping, fine-tuning, and/or human demonstration of the task (block stacking).

The present application involves solving automatically generated tasks to discover diverse and complex behaviors with minimal prior knowledge of the tasks. Hierarchical Reinforcement Learning (HRL) may compose pre-trained behaviors. A repertoire of pre-trained behaviors may increase the probability of success throughout the training of an orchestrator policy to maintain a usable reward signal from the environment. Mutual-information maximization between the skill identifier and the state of the environment as a task agnostic intrinsic reward may be used.

Systems and methods for skill learning, however, may struggle to produce skill repertoires for robotic manipulation. As an alternative, Multiplicative Compositional Policies (MCP) may be able to successfully learn skills, which may also referred to as primitives, for complex tasks in an end-to-end setting. This approach may involve jointly learning a set of policies and an orchestrator for a given downstream task. To adapt to a new task over a comparable environment, the orchestrator is retrained, hence preserving the behavioral knowledge embedded in the primitives.

However, learning a diverse set of composable behaviors may still involve an efficient approach to explore the possible actions allowed by the considered environment. The present application involves learning these behaviors by solving diverse tasks of progressive difficulty. This ensures the policy has a significant learning signal to learn from. Controlling the sequence of training tasks in GCRL is called curriculum learning. Asymmetric Self-Play (ASP) may be used for the curriculum learning. ASP may involve generation of increasingly difficult tasks and behaviors by making two agents compete on defining and solving tasks in an adversarial manner. As a consequence, it copes against the sparsity of the reward signal by maintaining a probability of success of the each agent.

As stated above, the present application involves a novel reusable and composable skill learning approach for manipulation based on such an ASP curriculum strategy with an MCP. With minimum supervision, the present application successfully learns a policy for a repertoire of composable skills that successfully solve complex manipulation tasks. The systems and methods described herein transfer to a real-world manipulation platform.

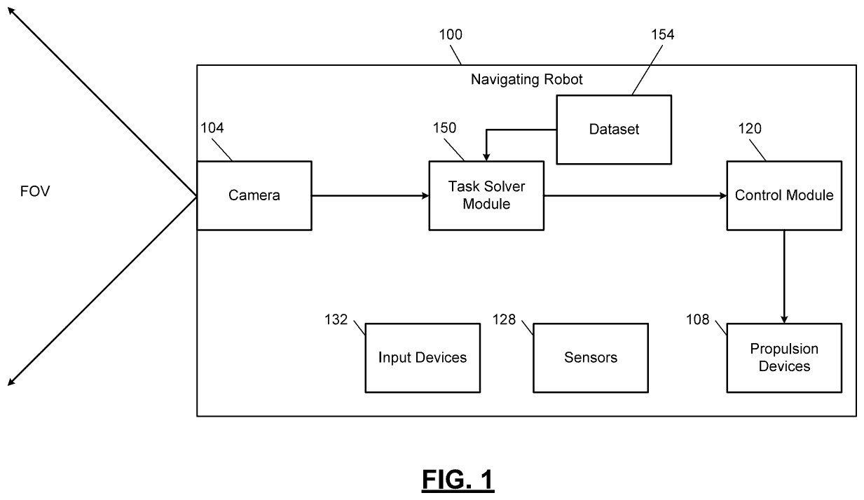

FIG. 1 is a functional block diagram of an example implementation of a navigating robot 100. The navigating robot 100 is a vehicle and is mobile. The navigating robot 100 includes a camera 104 that captures images within a predetermined field of view (FOV). The predetermined FOV may be less than or equal to 360 degrees around the navigating robot 100. The operating environment of the navigating robot 100 may be an indoor space (e.g., a building), an outdoor space, or both indoor and outdoor spaces.

The camera 104 may be, for example, a grayscale camera, a red, green, blue (RGB) camera, or another suitable type of camera. The camera 104 may or may not capture depth (D) information, such as in the example of a grayscale-D camera or a RGB-D camera. The camera 104 may be fixed to the navigating robot 100 such that the orientation of the camera 104 (and the FOV) relative to the navigating robot 100 remains constant. The camera 104 may update (capture images) at a predetermined frequency, such as 60 hertz (Hz), 120 Hz, or another suitable frequency. The navigating robot 100 may also include one or more other types of sensors, such as one or more light detection and ranging (LIDAR) sensors.

A task solver module 150 is trained to perform various different training tasks, such as navigation tasks. In the navigating robot 100, the task solver module 150 solves tasks, including tasks that are different than the training tasks, using primitives and skills stored in a dataset 154.

The navigating robot 100 may include one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly. The robot 100 is powered, such as via an internal battery and/or via an external power source, such as wirelessly (e.g., inductively). The control module 120 actuates the propulsion device(s) 108 to perform tasks from the task solver module 150.

While the example of a navigating robot is provided, the present application is also applicable to other types of robots.

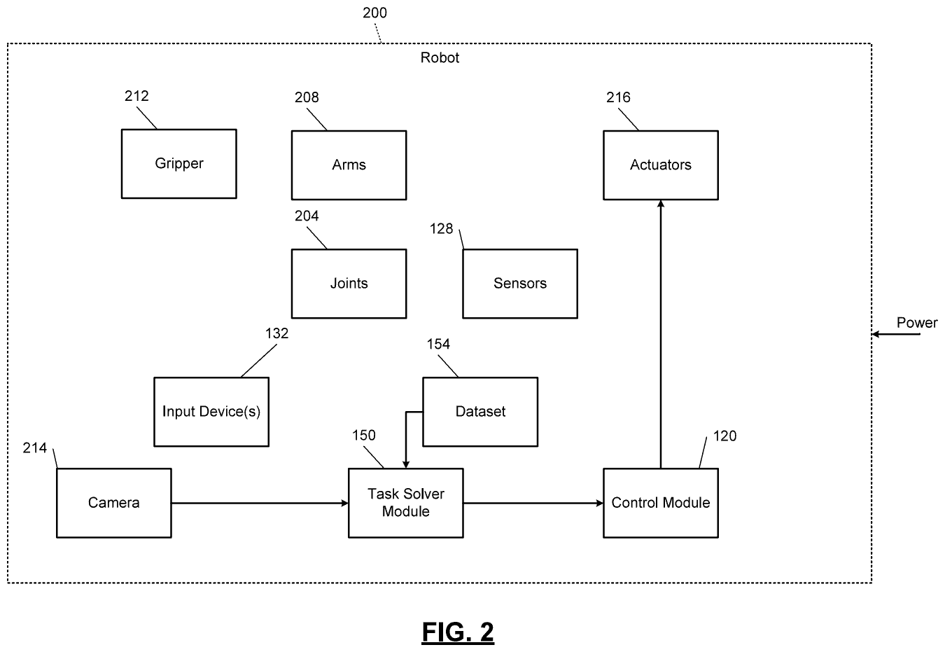

For example, FIG. 2 includes a functional block diagram of an example robot 200. The robot 200 may be stationary or mobile. The robot 200 may be, for example, a 5 degree of freedom (DoF) robot, a 6 DoF robot, a 7 DoF robot, an 8 DoF robot, or have another number of degrees of freedom. In various implementations, the robot 200 may include the Panda Robotic Arm by Franka Emika, the mini Cheetah robot, or another suitable type of robot.

The robot 200 is powered, such as via an internal battery and/or via an external power source, such as alternating current (AC) power. AC power may be received via an outlet, a direct connection, etc. In various implementations, the robot 200 may receive power wirelessly, such as inductively.

The robot 200 includes a plurality of joints 204 and arms 208. Each arm may be connected between two joints. Each joint may introduce a degree of freedom of movement of a (multi fingered) gripper 212 of the robot 200. The robot 200 includes actuators 216 that actuate the arms 208 and the gripper 212. The actuators 216 may include, for example, electric motors and other types of actuation devices.

In the example of FIG. 1, the control module 120 controls actuation of the propulsion devices 108. In the example of FIG. 2, the control module 120 controls the actuators 216 and therefore the actuation (movement, articulation, actuation of the gripper 212, etc.) of the robot 200.

The task solver module 150 plans movement of the robot 200 and performance of different tasks. An example of a task includes moving to and grasping and moving an object. The present application, however, is also applicable to other tasks, such as navigating from a first location to a second location while avoiding objects and other tasks. The control module 120 may, for example, control the application of power to the actuators 216 to control actuation and movement. Actuation of the actuators 216, actuation of the gripper 212, and actuation of the propulsion devices 108 will generally be referred to as actuation of the robot.

The robot 200 also includes a camera 214 that captures images within a predetermined field of view (FOV). The predetermined FOV may be less than or equal to 360 degrees around the robot 200. The operating environment of the robot 200 may be an indoor space (e.g., a building), an outdoor space, or both indoor and outdoor spaces.

The camera 214 may be, for example, a grayscale camera, a red, green, blue (RGB) camera, or another suitable type of camera. The camera 214 may or may not capture depth (D) information, such as in the example of a grayscale-D camera or a RGB-D camera. The camera 214 may be fixed to the robot 200 such that the orientation of the camera 214 (and the FOV) relative to the robot 200 remains constant. The camera 214 may update (capture images) at a predetermined frequency, such as 60 hertz (Hz), 120 Hz, or another suitable frequency. The robot 200 may also include one or more other types of sensors, such as one or more LIDAR sensors, etc.

The task solver module 150 may generate the task based on one or more images from the camera and/or one or more other inputs. The task solver module 150 may generate the task additionally or alternatively based on measurements from one or more sensors 128 and/or one or more input devices 132. Examples of sensors include position sensors, temperature sensors, location sensors, light sensors, rain sensors, force sensors, torque sensors, etc. Examples of input devices include touchscreen displays, joysticks, trackballs, pointer devices (e.g., mouse), keyboards, steering wheels, pedals, and/or one or more other suitable types of input devices.

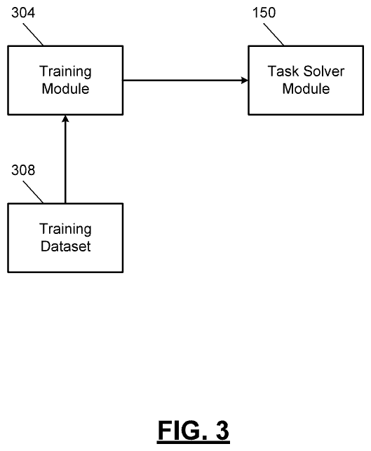

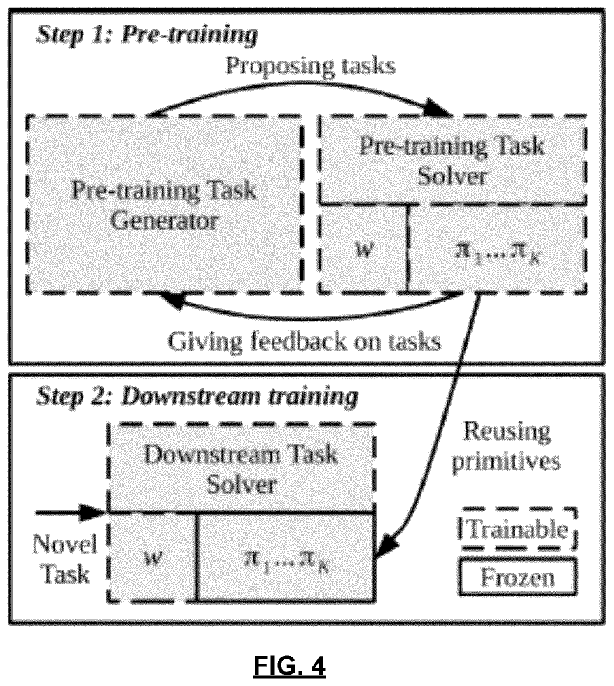

FIG. 3 is a functional block diagram of an example training system. FIG. 4 is a functional block diagram including an example implementation of the task solver module 150. A training module 304 trains the task solver module 150 using a training dataset 308. The training is discussed further below. In various implementations, the training module 304 may be implemented within the task solver module 150.

Considered herein is an environment with a fully-observable state s∈ [symbol] , a set of actions [symbol] , a state transition probability p(ₛₜ₊₁|sₜ, aₜ) where t denotes time and a reward function [symbol] : [symbol] → [symbol] . This formulates a Markov Decision Process (MDP), represented as a tuple ( [symbol] , p, [symbol] ).

A solution to an MDP is a policy π of the task solver module 150 π: [symbol] → [symbol] which specifies an action at given a state sₜ, at a given time t. The training module 304 trains the task solver module 150 based on finding an optimal policy π* that maximizes the expected discounted sum over a possibly infinite horizon: [symbol] [Σₜ₌₀^{∞}γ^{t} [symbol] (sₜ, aₜ)] where γ is a predetermined discount factor value.

For GCRL, when the policy π is solves multiple tasks, the task description may be given as input to the policy. Goal-conditioned policies may be modeled as π: [symbol] → [symbol] where [symbol] is the goal-space. A goal g∈ [symbol] specifies the task as a configuration of the robot to be achieved in the environment. In such goal-conditioned formulation, the reward function may be defined as goal-dependent, [symbol] : [symbol] →

[symbol]

The policy may be a multiplicative compositional policy (MCP). MCP may be a policy architecture that enables the task solver module 150 to activate multiple primitives simultaneously, where each primitive specializes in/is associated with different behaviors (the policy encodes a repertoire of composable skills). These primitives are composed by the task solver module 150 to produce a continuous spectrum of skills.

The probabilistic formulation accomplishes this by treating each of the K primitives π₁, . . . , π_{K} as a normal distribution over actions. The composite policy is obtained by a multiplicative composition of these distributions,

$$π ( a \vert s , g ) = \frac{1}{Z ( s , g )} {\prod }_{i = 1}^{k} {{π}_{i} ( a \vert s , g )}^{{w}_{i} ( s , g )} , where {w}_{i} ( s , g ) \geq 0. \qquad ( 1 )$$

A gating function w specifies each weight wᵢ(s, g)∈ [symbol] ₊, which determines the impact of the i-th primitive on the composite action distribution, with a larger weight corresponding to a larger influence and vice versa. The weights wᵢ(s, g) may not be normalized but may be bounded to between 0 and 1, wᵢ(s, g)∈[0,1].

Z(s, g) acts as a normalizing term and may not be computed. While the additive model of the task solver module 150 directly samples actions from the selected primitive's distribution, the multiplicative model of the task solver module 150 first combines the primitives, and then samples actions from the resulting distribution.

Each primitive πᵢ(a|s, g)=N(μᵢ(s, g), Σᵢ(s, g)) may be modeled by a Gaussian distribution with mean μᵢ(s, g) and diagonal covariance matrix Σᵢ(s, g)=diag(σᵢ¹(s, g), σᵢ²(s, g), . . . , [symbol] ) where σᵢ¹(s, g) denotes the variance of the j-th action parameter from the i-th primitive, and | [symbol] | represents the dimensionality of the action space. A multiplicative composition of Gaussian primitives yields yet another Gaussian policy π(a|s, g)= [symbol] (μ(s,g), Σ(s, g)).

Since the primitives model each dimension of the action with an independent Gaussian, the action parameters of the composite policy π also takes the form of independent Gaussians with component-wise mean u^{j}(s, g) and variance σ^{j}(s, g) where

$${μ}^{j} ( s , g ) = \frac{1}{{\sum }_{l = 1}^{k} \frac{{w}_{l} ( s , g )}{{σ}_{l}^{j} ( s , g )}} {\sum }_{i = 1}^{k} \frac{{w}_{i} ( s , g )}{{σ}_{i}^{j} ( s , g )} {μ}_{i}^{j} ( s , g ) and \qquad ( 2 )$$

$${μ}^{j} ( s , g ) = {( {\sum }_{i = 1}^{k} \frac{{w}_{i} ( s , g )}{{σ}_{l}^{j} ( s , g )} )}^{- 1} \qquad ( 3 )$$

The policy π of the task solver module 150 is a Gaussian policy, and the training module 304 trains the policy end-to-end using stochastic gradient descent (SGD).

The training module 304 trains the policy using Asymmetric self-play (ASP), a curriculum learning approach. In this regard, the training module 304 may be considered a goal generator and referred to as Alice. The task solver module 150 is a goal conditioned task solver and may be referred to as Bob. During the training, Bob (the task solver module) is asked to solve or reverse tasks/goals generated by Alice in the same environment. On the one hand, to encourage the discovery of increasingly challenging goals, Alice is rewarded for proposing goals that Bob is unable to solve. On the other hand, Bob is rewarded for solving the proposed goals. This adversarial reward structure yields a curriculum for Bob to learn from an set of tasks that increase in difficulty. At the end of the training, Bob, the task solver module 150, has been exposed to and learned from a diverse and complex distribution of tasks.

From an MDP perspective, given an environment, Alice and Bob solve two distinct decision problems. Alice aims at maximizing Bob's failure while producing an possible end-state in each episode. On the other hand, Bob aims at solving a goal-condition decision process where the resulting states of Alice's interactions become the goal to achieve. One advantage of the use of ASP is the capability of producing goals of progressive difficulty. Throughout the joint training, the training module and the task solver module 150 learn to produce increasingly difficult tasks and their associated behaviors.

The training of the task solver module 150 can be considered as two parts: pre-training followed by downstream training. The present application involves learning diverse, composable and reusable primitives by pre-training the task solver module 150 to solve a large set of tasks (e.g., at least a predetermined number) generated adversarially. This results in a set of primitives that captures a range of behaviors for completing the set of tasks embedded in the environment. The primitives (e.g., basic actions) can be composed and reused to solve various (unseen) tasks later during operation in the real world.

FIG. 4 is a functional block diagram and flow chart of an exam implementation of the training. As discussed above, the training module 304 first pre-trains the task solver module 150. This involves learning behaviors and primitives through being presented with diverse tasks to solve. During the pre-training, the training module 304 serves as a task generator. As the task generator, the training module 304 proposes tasks that that the task solver module 150 solves. If the distribution of tasks proposed is large and complex enough, it induces the discovery of diverse behaviors by the task solver module 150 that can later be used to complete tasks that the task solver module 150 is not trained to perform. While the example of ASP to create the large and complex distribution of tasks is provided, the present application is also applicable to other automatic task generation frameworks.

ASP may generate a diversity of complex tasks in a robotic manipulation setting. The task proposed by the training module 304 in ASP is also feasible to be solved by the task solver module 150. More importantly, each proposed task has an associated successful demonstration in the training dataset 308, which can be used by the training module 304 to train the task solver module 150 if the task solver module 150 is not able to solve the proposed task on its own. This can be particularly useful in a robotic manipulation setting in order to encourage proper interactions with objects, such as in early in the training. ASP allows for the introduction of priors regarding the tasks to be generated, which allows to penalize of undesired behaviors.

In a robotic manipulation setting, some tasks may be moving an object from one position to another position or orientation. Considered herein is a task is defined by two sets of positions: the set of initial and target positions of objects. The size of each set may be equal to the number of objects. With this formulation, a task may be considered solved when each object has achieved its target position or within a predetermined distance (d_{threshold}) of the target position.

Once the automatic task generation process (pre-training) is complete, such as once a predetermined number of proposals have been generated and the training module 304 is not proposing novel tasks anymore, and task solver module 150 is able to solve all of the proposed tasks. The task solver module 150 is then maintained for later use to solve (unseen) downstream tasks. The downstream training is the second portion of the training. As the task solver module 150 has been previously exposed to various tasks, its policies embeds a variety of behaviors (the primitives) that can be reused in the same environment.

The task solver module 150 may include a Multiplicative Compositional Policy (MCP) that embeds the whole range of behaviors discovered in the pre-training phase and to increase their reusability on downstream tasks. Learning the solver's policy as a monolithic policy, e.g. as a Multi-Layer Perceptron (MLP), may limit the range of options for downstream tasks. Reusing such a model may limit the range of downstream tasks to tasks with the same observation space or task formulation as in the first phase of training. For example, if the pre-training phase constrains tasks to be defined by target positions, tasks of other natures may not be learned with a monolithic policy. MCPs address this by separately learning a gating network (gating values), associated to the gating function of the policy, and a set of primitive networks, which parametrize each individual primitive. The task solver module 150 includes an asymmetric model where the gating function w (and not the primitives) observes the goal g while the primitives observe task agnostic information in the state s. This can be described by

$$π ( a \vert s , g ) = \frac{1}{Z ( s , g )} {\prod }_{i = 1}^{k} {{π}_{i} ( a \vert s , g )}^{{w}_{i} ( s , g )} \qquad ( 4 )$$

$$where$$

$$π ( a \vert s ) = 𝒩 ( {μ}_{i} ( s ) , {\sum }_{i} ( s ) ) \qquad ( 5 )$$

As the primitives may be based on task-agnostic information, they can be transferred to new tasks that share similar observation spaces but have different task-dependent information, such as different goal spaces. In various implementations, the observation space of primitives may be limited even more, such as by limiting the observation space only to information that is available in a real-world environment. This may help to bridge the gap between the simulation space and the real world.

Even if the downstream tasks rely on the same observation space and goal space as the downstream task, the training module 304 may perform fine-tuning on the task solver module 150. This may increase performance. This may occur if there is a significantly large difference between the pre-training and downstream task distributions. While fine-tuning can increase performance on some tasks, it may introduce possible catastrophic forgetting of the embedded behaviors learned during the pre-training. A benefit of MCPs is that task agnostic behaviors are embedded in the primitives' network. By freezing the primitives' network parameters and finetuning the task solver module 150 or learning one from scratch, the primitives' prior knowledge is preserved while new tasks can be learned by the task solver module 150.

Learning primitives to solve a large set of tasks in the pre-training phase may increase utility and usability for this set of tasks. The task solver module 150 after the pre-training phase may serve as a lower bound in terms of possible performance with its learned primitives. If primitives can be composed to solve a sufficiently diverse set of manipulation tasks during pre-training, the primitives can then be repurposed and used by the task solver module 150 after the pretraining to solve for not previously seen downstream tasks in real environments. In various implementations, the fine tune training may not be performed.

The training environment may be, for example, a version of the Panda-Gym environment or another suitable training environment. The version of the Panda-Gym environment includes a robotic arm, a Franka Emika Panda robot, placed on a table-top setting where objects can be manipulated. Manipulation tasks involving either one or two objects may be used for the training.

The action space is four-dimensional and includes displacement of the end-effector defined in [symbol] ³ and of the fingers defined in [symbol] . As the primitives are orchestrated by a gating function for solving downstream manipulation tasks, the perceived action space of the orchestration may be the same as the output space of the gating function, [0,1]_{K} where K is the number of primitives.

Regarding observation space, actor-critic RL algorithms may be used where both the actor and the critic share the same observation. The shared observations space includes the end-effector position in [symbol] ³ and of the finger width defined in [symbol] . The object absolute positions defined in [symbol] ³ per object, and object positions relative to the end-effector position defined in [symbol] ³ per object.

During pre-training, Alice's observation space may be augmented with the end-effector velocity defined in [symbol] ³, the finger velocity defined in [symbol] , object velocities defined in [symbol] ³ per object, the number of steps Alice has taken since the last reset of the environment defined in [symbol] , and binary values which indicate whether an object is in contact with a finger defined in {0,1}₂ per object. Including this information facilitates the discovery of new tasks and behaviors, such as grasping objects. Bob's policy is an MCP. Its primitive networks have the shared observation space stated above. Bob's gating network has the same observation space to task-specific information may be appended, such as by the training module 304. This may include the target positions of objects defined in [symbol] ³ per object.

Regarding the reward function, sparse reward functions may be used during the pre-training and downstream training. During the pre-training, Bob, the task solver module 150, may be rewarded for solving the task at the moment the task is solved. Additionally, Bob may receive rewards during the episode if Bob either moves an object from its target position, r_{object}=−1 or he moves on object on its target position r_{object}=+1. Alice, the training module 304, may be rewarded at the end of each episode and receive a reward r_{valid}=+1 if she proposes goal positions in a predetermined area on the table top, validity area, and if such positions are different from the initial position of objects. If the goal is valid, Alice gets an additional reward r_{difficult}=5 if Bob fails to solve the task or r_{difficult}=0 if Bob succeeds.

During the downstream training phase, the orchestrator (the task solver module 150) is rewarded at every step for each object on its target. The range and dimension of the latent variable z may be limited. For example, z∈[−1, +1]_{K} may be used, which may provide fairness. The primitives may be orchestrated with a gate w(s, g)∈[0, +1]_{K}. In various implementations, K may be equal to 4. Observations may be standardized with running statistics. During the downstream training, the returns may be normalized by the training module 304 such as with per episode statistics.

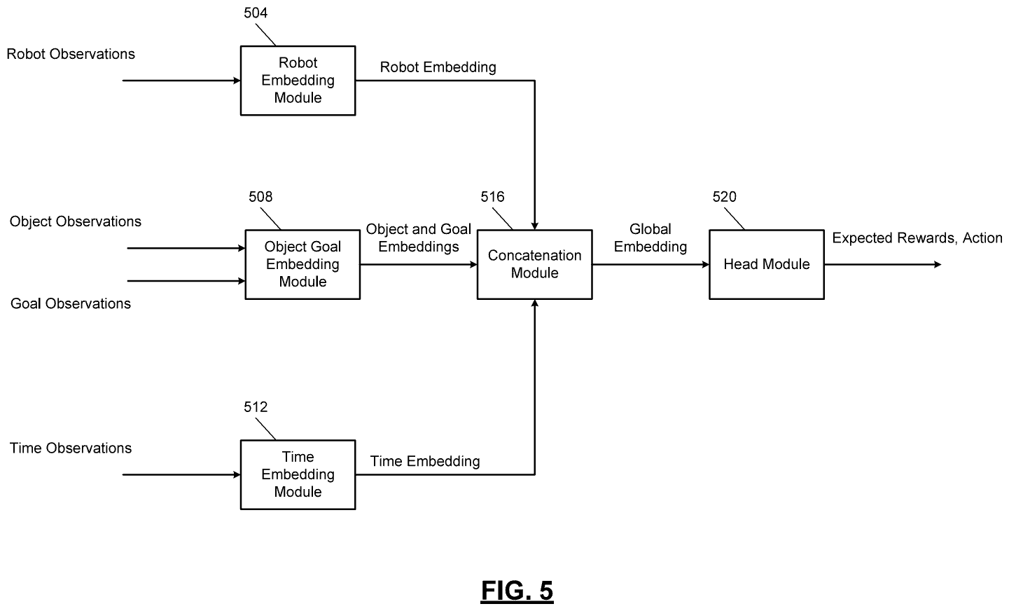

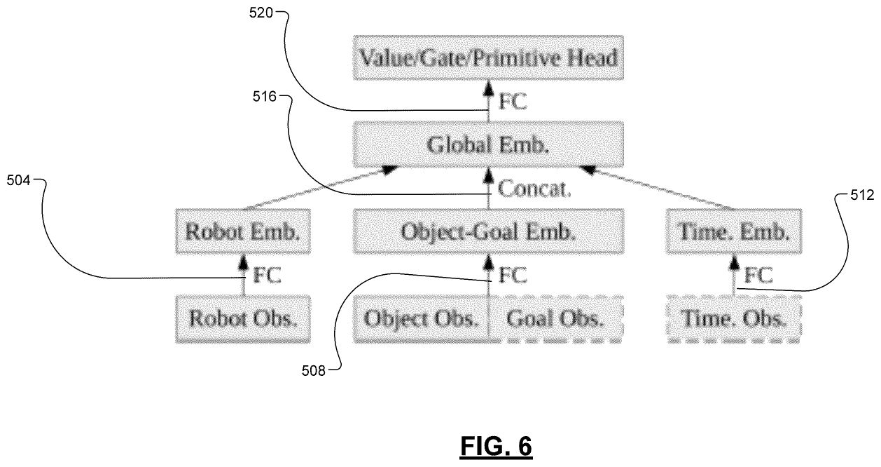

FIGS. 5 and 6 include functional block diagrams of an example implementation of the primitives (modules). Each of the primitives may have the same architecture.

The primitive includes a robot (first) embedding module 504 that embeds robot observations using an embedding algorithm into a robot embedding. Examples of the robot observations may be based on or include images from the camera, measurements from sensors of the robot, and other data. The primitive also includes an object goal (second) embedding module 508 that embeds object observations and goal observations using an embedding algorithm into object and goal embeddings, respectively. In various implementations, the object and goal embeddings may be combined into a single embedding. An example of the object observations may be based on or include a present pose and position of the object to be manipulated. An example of the goal observations may be based on or include the target pose and position of the object to be manipulated. The primitive also includes a time (third) embedding module 512 that embeds time observations using an embedding algorithm into a time embedding. Examples of the time observations may be based on or include information regarding time steps sin the beginning of the present episode. The robot, object goal, and time embedding modules may include, for example, fully connected layers, such as fully connected neural networks, or another suitable architecture. In various implementations, during the training, the goal observation may be provided to the task solver module 150 only and not to the training module 304. The time observation may be provided only to the training module 304 and not to the task solver module 150. In various implementations, each primitive may include one or more multi layer perceptrons (MLPs).

A concatenation module 516 concatenates the robot, object and goal, and time embeddings into a global embedding. A head module 520 determines, based on the global embedding, actions to be performed by the robot at the current time. The head module 520 an expected rewards for the actions, respectively. The head module 520 may select the one of the actions to be performed having the highest expected reward. The control module 120 actuates the robot according to the selected action. In various implementations, the head module 520 may include one or more fully connected layers, such as one or more fully connected neural networks.

One benefit of the architecture of FIGS. 5 and 6 is its agnosticism to the number of objects in the scene. Once trained, the primitives span a larger range of reachable object positions, despite the fact they were trained to operate in a smaller workspace. This may be due to retrial behaviors learned by Bob, which may be behaviors allowing for recovery of an object that moved far from the area. The present application does not suffer from sparsity during pre-training, such as due to the curriculum induced by SP and from Alice's successful demonstrations that Bob can learn from.

The orchestrator is trained by the training module 304 to output the gate w(s,g) to compose the primitives or the latent variable z(s,g) for baselines, in order to control the behaviors of the robot. w may be considered a multiplicative orchestrator. For other baselines, the task solver module 140 is directly trained by the training module 304 to output the action associated with the action space of the environment. For the single-object tasks, the orchestrators may use the same set of primitives. For tasks involving two objects, a set of primitives pre-trained in a two-object setting may be used.

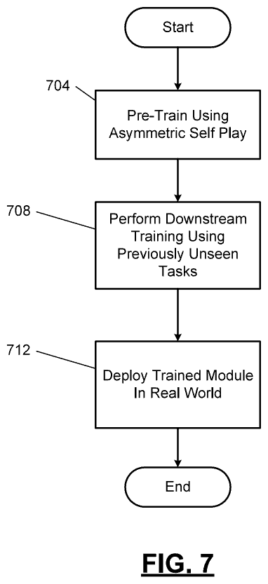

FIG. 7 is a flowchart depicting an example method. Control begins with 704 where the training module 304 trains the primitives of the task solver module 150 as described above using asymmetric self play. At 708, the training module performs downstream training of the task solver module 150 as described above based on tasks unseen during the pre-training. At 712, the robot can be deployed to solve for tasks in the real world environment.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A training system for a robot, comprising:
a task solver module including primitive modules and a policy and configured to determine how to actuate the robot to solve input tasks; and
a training module configured to:
pre-train ones of the primitive modules for different actions, respectively, of the robot and the policy of the task solver module using asymmetric self play and a set of training tasks; and
after the pre-training, train the task solver module using others of the primitive modules and tasks that are not included in the set of training tasks.

2. The training system of claim 1 wherein the policy of the task solver module is a multiplicative compositional policy (MCP).

3. The training system of claim 1 wherein the primitive modules are associated with distributions over actions, respectively,
wherein the policy of the task solver module is a multiplicative composition of the distributions, and
wherein the multiplicative composition of the distributions defines a repertoire of composable skills for the robot.

4. The training system of claim 1 wherein the asymmetric self play includes the training module presenting the task solver module with tasks of increasing difficulty over time.

5. The training system of claim 1 wherein the task solver module includes a gating function that includes weights to apply to outputs of the primitive modules, respectively.

6. The training system of claim 1 wherein the training module is configured to train the weights.

7. The training system of claim 1 wherein each of the primitive modules is modeled by a Gaussian distribution.

8. The training system of claim 1 wherein the policy is configured to maximize an expected discounted sum over a horizon.

9. The training system of claim 1 wherein each of the primitive modules includes an embedding module configured to generate an embedding based on at least one measurement from at least one sensor of the robot, and the robot includes a control module configured to actuate one or more actuators of the robot based on the embedding.

10. The training system of claim 9 wherein the embedding module includes at least one fully connected layer.

11. The training system of claim 1 wherein each of the primitive modules includes an embedding module configured to generate an embedding based on at an image captured using a camera of the robot, and the robot includes a control module configured to actuate one or more actuators of the robot based on the embedding.

12. The training system of claim 11 wherein the embedding module includes at least one fully connected layer.

13. The training system of claim 1 wherein each of the primitive modules includes an embedding module configured to generate an embedding based on a position and a pose of an object to be manipulated by the robot, and the robot includes a control module configured to actuate one or more actuators of the robot based on the embedding.

14. The training system of claim 13 wherein the embedding module includes at least one fully connected layer.

15. The training system of claim 1 wherein each of the primitive modules includes an embedding module configured to generate an embedding based on a target position and a target pose of an object to be manipulated by the robot, and the robot includes a control module configured to actuate one or more actuators of the robot based on the embedding.

16. The training system of claim 15 wherein the embedding module includes at least one fully connected layer.

17. The training system of claim 1 wherein each of the primitive modules includes:
a first embedding module configured to generate a first embedding based on at least one of (a) at least one measurement from at least one sensor of the robot and (b) an image captured using a camera of the robot; and
a second embedding based on at least one of (a) a position and a pose of an object to be manipulated by the robot and (b) a target position and a target pose of the object to be manipulated by the robot,
wherein the robot includes a control module configured to actuate one or more actuators of the robot based on the first embedding and the second embedding.

18. The training system of claim 17 wherein each of the primitive modules further includes a concatenation module configured to generate a third embedding by concatenating the first and second embeddings,
wherein the control module is configured to actuate the one or more actuators of the robot based on the third embedding.

19. The training system of claim 1 wherein each of the primitive modules includes an embedding module configured to generate an embedding based on time steps since a beginning of an episode of the training, and the robot includes a control module configured to actuate one or more actuators of the robot based on the embedding.

20. A training method for a robot, comprising:
pre-training ones of primitive modules for different actions, respectively, of the robot and a policy of a task solver module using asymmetric self play and a set of training tasks, the task solver module including the primitive modules and the policy and configured to determine how to actuate the robot to solve input tasks; and
after the pre-training, training the task solver module using others of the primitive modules and tasks that are not included in the set of training tasks.

21. A robot, comprising:
a task solver module including primitive modules and a policy and configured to determine how to actuate the robot to solve an input task,
each of the primitive modules including an embedding module configured to generate an embedding based on at least one measurement from at least one sensor of the robot; and
a control module configured to actuate one or more actuators of the robot based on the embedding,
wherein the policy encodes a repertoire of composable skills for performing the input task.
